(19) United States
(12) Patent Application Publication
(10) Pub. No.: US 2025/0269442 A1
(43) Pub. Date: Aug. 28, 2025

(54) CUTTING TOOL AND INDEXABLE CUTTING INSERT HAVING A PLURALITY OF CIRCUMFERENTIAL CUTTING PORTIONS AND A CENTRAL MOUNTING PORTION

(71) Applicant: ISCAR, LTD., TEFEN (IL)

(72) Inventors: JACOB HARPAZ, KFAR VRADIM (IL); GIL HECHT, NAHARIYA (IL)

(73) Assignee: ISCAR, LTD., TEFEN (IL)

(21) Appl. No.: 18/589,613

(22) Filed: Feb. 28, 2024

(51) Int. Cl. B23C 5/20

(52) U.S. Cl. CPC B23C 5/20

(57) ABSTRACT

A cutting tool has an indexable cutting insert removably secured to a holding portion of an insert holder. The cutting insert has opposing first and second end surfaces with a peripheral side surface extending therebetween and a central mounting portion. The cutting insert has a plurality of cutting portions circumferentially spaced apart about a central axis, each cutting portion having a rake and relief surfaces located on the peripheral side surface. The central mounting portion has a plurality of female type or male type mounting elements having opposing first and second mounting flanks. The plurality of rake surfaces and first mounting flanks face in a first direction about the central axis, the plurality of second mounting flanks face in a second direction about the central axis opposite to the first direction, and each second mounting flank extends further from the central axis than its associated opposing first mounting flank.

### FIELD OF THE INVENTION

The present invention relates to a cutting tool and an indexable cutting insert having a plurality of circumferential cutting portions and a central mounting portion, for use in metal cutting processes in general, and for groove turning and parting operations in particular.

### BACKGROUND OF THE INVENTION

Within the field of metal cutting tools used in groove turning and parting operations, cutting inserts removably securable in an insert holder have long since provided a way of performing a cutting operation with a suitably hard material, i.e., cemented carbide, in the vicinity of the cutting edge, where the insert holder, manufactured from a less hard material, is reusable following the replacement of a worn or damaged cutting insert.

This type of cutting tool has been further developed to utilize indexable cutting inserts with an increased number of cutting edges, giving economic benefits from providing an increased number of cutting operations per cutting insert. This type of cutting tool has also been developed to provide a more efficient means of securing the indexable insert to the insert holder.

DE3446455 A1 discloses a turning tool, serving in particular for longitudinal turning and face turning on lathes. The turning tool consists of a rod-shaped holder shank which has at least one flat bearing surface extending in the longitudinal direction and is provided with a locating surface arranged recessed in the rod cross-section for accommodating a throw-away cutting tool tip consisting for example of hard metal. In order to be able to use a cutting-tool tip with four long principal cutting edges and secure and arrange the latter on the holder shank by means of an easily accessible screw and arrange them such that the cutting pressure is directed roughly parallel to the locating surface, the roughly square-shaped flat throw-away cutting-tool tip has on the same flat side four V-shaped grooves intersecting at the point of intersection of the diagonals. The locating surface, which runs almost vertically relative to the bearing surface, is provided with at least two V-shaped supporting ridges running at right angles to one another, which ridges align the throw-away cutting-tool tip so that a cutting edge is in the cutting position.

CN213437234 U discloses a six-edge cutting blade which comprises a body, the body being provided with a front face, a back face and side faces, and a mounting hole penetrating through the upper surface and the lower surface and formed in the center of the body. A plurality of cutter arms is uniformly distributed on the body around the circumference of the mounting hole, and a first cutting edge is formed on the front surface of each cutter arm; a chip groove is formed in the side surface of the tool arm; and a positioning convex rib corresponding to each cutter arm is formed on the back surface of the body. The six-blade cutting tool can perform different operation machining applications such as face milling, groove milling, grooving and excircle cutting machining can be achieved, and the six-blade cutting tool is wide in application. The positioning convex ribs are arranged on the back face of the six-blade cutting knife and matched with the positioning grooves in the knife handle, and during installation, rapid assembly and accurate position correction can be achieved through matching of the positioning convex ribs and the positioning grooves.

It is an object of the present invention to provide an improved indexable cutting insert suitable for groove turning and parting operations.

It is also an object of the present invention to provide an improved indexable cutting insert giving good support against cutting forces.

It is a further object of the present invention to provide an improved cutting tool capable of performing groove turning and parting operations with relatively large cutting depths.

### SUMMARY OF THE INVENTION

In accordance with one aspect of the present invention, there is provided an indexable cutting insert comprising:
opposing first and second end surfaces with a peripheral side surface extending therebetween,
   a central axis transverse to the first and second end surfaces, about which the cutting insert is indexable,
   a median plane located between the first and second end surfaces,
   a central bore coaxial with the central axis intersecting the first and second end surfaces, and
   at least one of the first and second end surfaces having a central mounting portion,
the cutting insert having a plurality of N cutting portions circumferentially spaced apart about the central axis, whereby N is a specific integer number of at least three,
   each cutting portion having a primary cutting edge formed at the intersection of a rake surface and a relief surface, and each primary cutting edge having a radially outermost cutting point and first and second end points,
      the plurality of N rake surfaces and the plurality of N relief surfaces located on the peripheral side surface, and
      the plurality of N rake surfaces facing in a first rotational direction about the central axis,
wherein:
the central mounting portion comprises a plurality of N female type or male type mounting elements, each mounting element having opposing first and second mounting flanks extending along a mounting axis, each of the first and second mounting flanks configured to make clamping contact in at least one index position of the cutting insert,
and wherein in an end view of the cutting insert:
the first and second mounting flanks of each mounting element are located on opposite sides of their associated mounting axis,
each mounting axis traverses the central bore,
the plurality of N first mounting flanks face in the first rotational direction about the central axis,
the plurality of N second mounting flanks face in a second rotational direction about the central axis opposite to the first direction, and
each second mounting flank extends further from the central axis than its associated opposing first mounting flank.

In accordance with another aspect of the invention, there is provided a cutting tool comprising an insert holder and a cutting insert of the sort described above retained therein,
the insert holder having a holding portion extending along a holding axis in a forward to rearward direction, and the cutting insert removably securable to the holding portion in any one of N index positions,
   the holding portion having a front holding surface facing in the forward direction and opposing first and second side holding surfaces extending rearwardly from the front holding surface,
      the first side holding surface having an engagement portion comprising three male type or three female type engagement elements, each engagement element having opposing first and second engagement flanks extending along an engagement axis,
wherein, in each index position of the cutting insert:
three of the plurality of N female type or male type mounting elements operatively engage with the three male type or three female type engagement elements,
the three first mounting flanks of said three operative mounting elements make clamping contact with the three first engagement flanks of the three male type or three female type engagement elements,
the three second mounting flanks of said three operative mounting elements make clamping contact with the three second engagement flanks of the three male type or three female type engagement elements,
only one of the cutting portions is an operative cutting portion, and
the single operative cutting portion extends beyond the front holding surface in the forward direction.

### BRIEF DESCRIPTION OF THE DRAWINGS

For a better understanding, the invention will now be described, by way of example only, with reference to the accompanying drawings in which chain-dash lines represent cut-off boundaries for partial views of a member and in which:

FIG. 1 is a perspective view of a cutting insert in accordance with some embodiments of the present invention;

FIG. 2 is an end view of the cutting insert shown in FIG. 1;

FIG. 3 is a side view of the cutting insert shown in FIG. 1;

FIG. 4 is a detailed view of the cutting insert shown in FIG. 3;

FIG. 5 is a detailed cross-sectional view of the cutting insert shown in FIG. 2, taken along the line V-V;

FIG. 6 is a cross-sectional view of the cutting insert shown in FIGS. 3 and 4, taken along the line VI-VI;

FIG. 7 is a perspective view of a cutting tool in accordance with some embodiments of the present invention;

FIG. 8 is an exploded perspective view of the cutting tool shown in FIG. 7;

FIG. 9 is a first side view of the cutting tool shown in FIG. 7;

FIG. 10 is a front end view of the cutting tool shown in FIG. 7;

FIG. 11 is a projected second side view of the cutting tool shown in FIG. 7;

FIG. 12 is a detailed cross-sectional view of the cutting tool shown in FIG. 11, taken along the line XII-XII;

FIG. 13 is a first side view of an insert holder in accordance with some embodiments of the present invention;

FIG. 14 is a front end view of the insert holder shown in FIG. 13;

FIG. 15 is a perspective view of the insert holder in accordance with an alternative embodiment of the present invention;

FIG. 16 is a first side view of the insert holder shown in FIG. 15;

FIG. 17 is a detailed cross-sectional view of the insert holder shown in FIG. 16, taken along the line XVII-XVII; and

FIG. 18 is a first side view of the cutting tool shown in accordance with an alternative embodiment of the present invention.

### DETAILED DESCRIPTION OF THE INVENTION

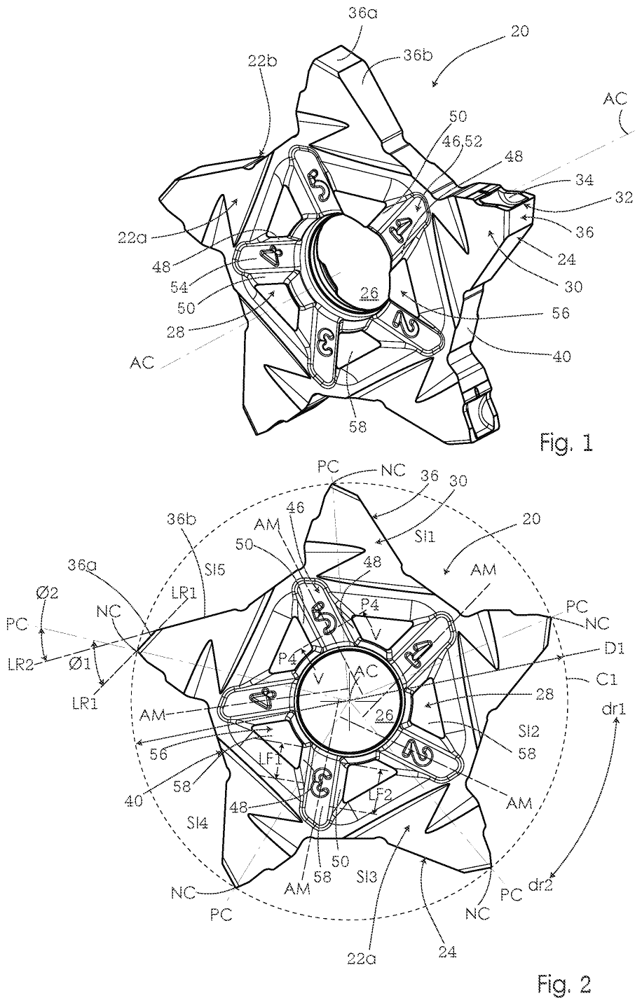

Attention is drawn to FIGS. 1 to 3, showing an indexable cutting insert 20 which may be manufactured by form pressing and sintering a cemented carbide, such as tungsten carbide, and may be coated or uncoated.

The cutting insert 20 has opposing first and second end surfaces 22a, 22b with a peripheral side surface 24 extending therebetween, and a central axis AC transverse to the first and second end surfaces 22a, 22b, about which the cutting insert 20 is indexable.

As shown in FIG. 2, the peripheral side surface 24 is continuous, defining a circumferential boundary of the first and second end surfaces 22a, 22b.

A median plane M is located between the first and second end surfaces 22a, 22b, and a central bore 26 coaxial with the central axis AC intersects the first and second end surfaces 22a, 22b.

By virtue of the central bore 26 intersecting the first and second end surfaces 22a, 22b, the central bore 26 may be described as a through bore.

In some embodiments of the present invention, the median plane M may be perpendicular to the central axis AC.

At least one of the first and second end surfaces 22a, 22b has a central mounting portion 28.

In some embodiments of the present invention, both the first and second end surfaces 22a, 22b may have central mounting portions 28.

As shown in FIGS. 1 and 2, the cutting insert 20 has a plurality of N cutting portions 30 circumferentially spaced apart about the central axis AC, whereby N is a specific integer number of at least three, i.e., N≥3.

In some embodiments of the present invention, N may be less than seven, i.e., N<7.

Also, in some embodiments of the present invention, N may equal five, i.e., N=5.

Further, in some embodiments of the present invention, the plurality of N cutting portions 30 may be identical.

Each cutting portion 30 has a primary cutting edge 32 formed at the intersection of a rake surface 34 and a relief surface 36, and the plurality of N rake surfaces 34 and the plurality of N relief surfaces 36 are located on the peripheral side surface 24.

As shown in FIG. 2, the plurality of N rake surfaces 34 face in a first rotational direction dr1 about the central axis AC, and the cutting insert 20 may be suitable for use in parting operations.

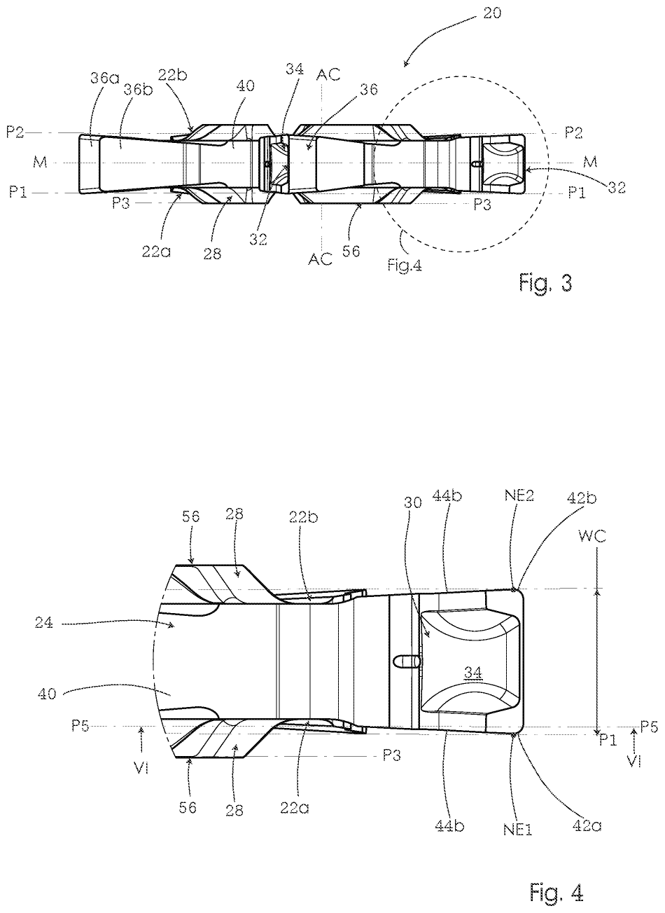

As shown in FIGS. 3 and 4, each primary cutting edge 32 has a main cutting edge-portion 38 intersecting the median plane M.

In some embodiments of the present invention, the main cutting edge-portion 38 may be linear and preferably parallel to the central axis AC.

Also, in some embodiments of the present invention, each relief surface 36 may comprise first and second relief sub-surfaces 36a, 36b, the first relief sub-surface 36a disposed immediately adjacent its associated primary cutting edge 32, and the second relief sub-surface 36b spaced apart from its associated primary cutting edge 32 by the first relief sub-surface 36a.

As shown in FIGS. 1 and 2, the peripheral side surface 24 may include a plurality of N transition surfaces 40 circumferentially spaced apart about the central axis AC and circumferentially alternating with the plurality of N cutting portions 30.

In some embodiments of the present invention, the median plane M may intersect the plurality of N transition surfaces 40.

Also, in some embodiments of the present invention, each of the plurality of N transition surfaces 40 may be planar.

As shown in FIG. 4, each primary cutting edge 32 has first and second end points NE1, NE2.

In some embodiments of the present invention, the first and second end points NE1, NE2 of each primary cutting edge 32 may be the furthest spaced apart points of said primary cutting edge 32 in a direction parallel to the central axis AC.

Also, in some embodiments of the present invention, each primary cutting edge 32 may have first and second curved corner cutting edge-portions 42a, 42b extending between the main cutting edge-portion 38 and first and second end points NE1, NE2, respectively.

Further, in some embodiments of the present invention, each cutting portion 30 may have first and second secondary cutting edges 44a, 44b extending away from its primary cutting edge 32 and associated first and second end points NE1, NE2, respectively, the first and second secondary cutting edges 44a, 44b being formed at the intersection of the cutting portion's rake surface 34 and the first and second end surfaces 22a, 22b, respectively.

For such embodiments of the present invention, the cutting insert 20 may be suitable for use in groove turning operations as well as parting operations.

Also as shown in FIGS. 3 and 4, a first plane P1 perpendicular to the central axis AC contains the first end point NE1 of at least one primary cutting edge 32, and a second plane P2 perpendicular to the central axis AC contains the second end point NE2 of said at least one primary cutting edge 32.

In some embodiments of the present invention, the first and second planes P1, P2 may be located on opposite sides of the median plane M.

Also, in some embodiments of the present invention, the first plane P1 may intersect the central mounting portion 28.

Further, in some embodiments of the present invention, the plurality of N first end points NE1 and the plurality of N second end points NE2 may be located on opposite sides of the median plane M.

As shown in FIGS. 3 and 4, the first plane P1 may contain the first end point NE1 of each of the plurality of N primary cutting edges 32.

In some embodiments of the present invention, apart from containing the plurality of N first end points NE1, the first plane P1 may not intersect any of the plurality of N cutting portions 30, such that each cutting portion 30 is provided with the necessary clearance for parting and groove turning operations.

Also, in some embodiments of the present invention, the central mounting portion 28 may traverse the first plane P1 and protrude beyond the plurality of N cutting portions 30, in a direction parallel to the central axis AC.

As shown in FIGS. 3 and 4, the second plane P2 may contain the second end point NE2 of each of the plurality of N primary cutting edges 32.

In some embodiments of the present invention, apart from containing the plurality of N second end points NE2, the second plane P2 may not intersect any of the plurality of N cutting portions 30, such that each cutting portion 30 is provided with the necessary clearance for parting and groove turning operations.

As shown in FIGS. 1 and 2, the central mounting portion 28 comprises a plurality of N female type or N male type mounting elements 46, each mounting element 46 having opposing first and second mounting flanks 48, 50 extending along a mounting axis AM.

Each of the first and second mounting flanks 48, 50 is configured to make clamping contact in at least one index position of the cutting insert 20.

It should be appreciated that the central mounting portion 28 may traverse the first plane P1 and protrude beyond the plurality of N cutting portions 30 when configured with a plurality of N female type mounting elements 46 and also when configured with a plurality of N male type mounting elements 46.

In some embodiments of the present invention, each of the plurality of N female type or N male type mounting elements 46 may be elongated.

Also, in some embodiments of the present invention, each mounting axis AM may be parallel to the median plane M.

Further, in some embodiments of the present invention, the first plane P1 may intersect the plurality of N female type or N male type mounting elements 46 and their associated first and second mounting flanks 48, 50.

Yet further, in some embodiments of the present invention, the plurality of N female type or N male type mounting elements 46 may be identical.

Yet still further, in some embodiments of the present invention, as shown in FIGS. 1 and 2, the plurality of N female type or N male type mounting elements 46 may be female type mounting channels 52.

For embodiments of the present invention in which the plurality of N female type or N male type mounting elements 46 are female type mounting channels 52, the opposing first and second mounting flanks 48, 50 of each mounting element 46 may face towards each other.

As shown in FIGS. 1 and 2, the opposing first and second mounting flanks 48, 50 of each mounting element 46 may be spaced apart by an intermediate surface 54.

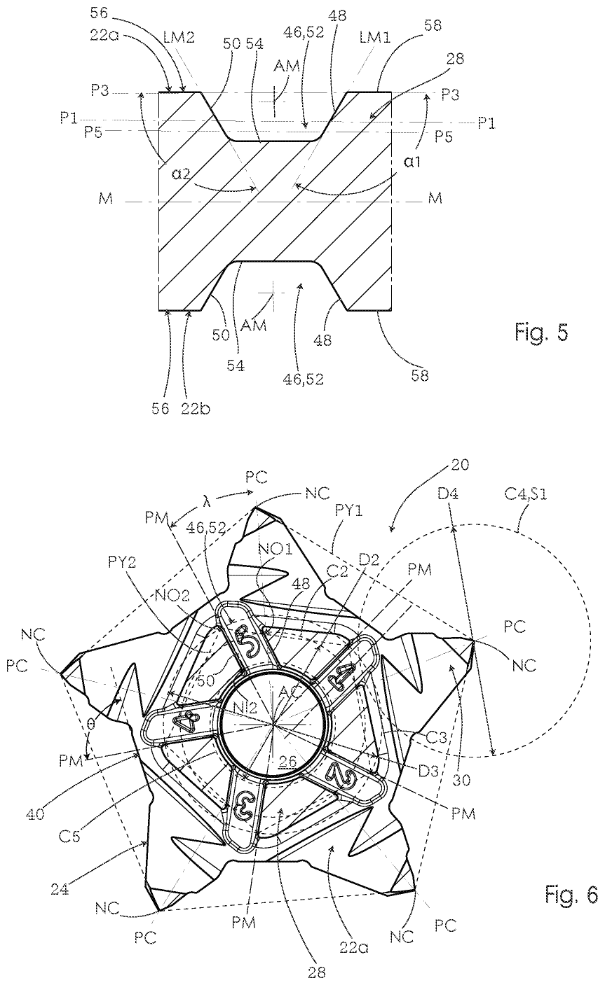

For embodiments of the present invention in which the plurality of N female type or N male type mounting elements 46 are female type mounting channels 52, as shown in FIG. 5, the plurality of N intermediate surfaces 54 may be located closer to the median plane M than the first plane P1.

As shown in FIGS. 3 and 4, the central mounting portion 28 has an outer mounting surface 56 defining a third plane P3 parallel to the median plane M.

In some embodiments of the present invention, the outer mounting surface 56 may comprise a plurality of N distinct, spaced apart co-planar mounting sub-surfaces 58.

Also, in some embodiments of the present invention, no portion of the cutting insert 20 may traverse the third plane P3.

Further, in some embodiments of the present invention, the cutting insert 20 may exhibit mirror symmetry about the median plane M.

Yet further, in some embodiments of the present invention, the cutting insert 20 may exhibit N-fold rotational symmetry about the central axis AC.

In an end view of the cutting insert 20, as shown in FIG. 2, the first and second mounting flanks 48, 50 of each mounting element 46 are located on opposite sides of their associated mounting axis AM, and each mounting axis AM traverses the central bore 26.

In some embodiments of the present invention, the first and second mounting flanks 48, 50 of each mounting element 46 may extend parallel to their associated mounting axis AM.

Also, in some embodiments of the present invention, each mounting axis AM may be located midway between its associated first and second mounting flanks 48, 50.

In the end view of the cutting insert 20, as shown in FIG. 2, the plurality of N first mounting flanks 48 face in the first rotational direction dr1 about the central axis AC, the plurality of N second mounting flanks 50 face in a second rotational direction dr2 about the central axis AC opposite to the first rotational direction dr1, and each second mounting flank 50 extends further from the central axis AC than its associated opposing first mounting flank 48.

By configuring each second mounting flank 50 to extend further from, or to a greater radial distance from, the central axis AC than its associated opposing first mounting flank 48, it should be appreciated that the capability of each second mounting flank 50 to transfer moments of force about the central axis AC may be greater than that of each first mounting flank 48.

In some embodiments of the present invention, each second mounting flank 50 may be longer than its associated opposing first mounting flank 48. FIG. 2 shows the first and second mounting flanks 48, 50 of each mounting element 46 having first and second flank lengths LF1, LF2, respectively, measured parallel to their associated mounting axis AM, whereby the second flank length LF2 of each mounting element 46 is greater than its associated first flank length LF1.

Also, in some embodiments of the present invention, in the end view of the cutting insert 20, as shown in FIG. 2, the second mounting flank 50 of each mounting element 46 may be located on the same side of its associated mounting axis AM as the central axis AC. For such embodiments of the present invention, the first mounting flank 48 of each mounting element 46 is located on the opposite side of its associated mounting axis AM than the central axis AC.

Further, in some embodiments of the present invention, in the end view of the cutting insert 20, the central mounting portion 28 may have the shape of a regular N-sided polygon with a center coincident with the central axis AC.

As shown in FIG. 5, in a cross-section taken in a fourth plane P4 (see FIG. 2) transverse to the mounting axis AM of one of the plurality of N mounting elements 46, straight first and second imaginary mounting lines LM1, LM2 coincident with or tangential to the first and second mounting flanks 48, 50, respectively, may form obtuse internal first and second mounting flank angles α1, α2, respectively, with the outer mounting surface 56.

It should be appreciated that use of the term “internal angle” throughout the description and claims refers to an angle between two surface components or imaginary lines tangential to two surface components as measured internal to the member on which these components are formed.

In some embodiments of the present invention, the fourth plane P4 may be perpendicular to one of the mounting axes AM.

Also, in some embodiments of the present invention, each of the plurality of N first mounting flanks 48 may be planar, and each of the plurality of N second mounting flanks 50 may be planar.

Further, in some embodiments of the present invention, the obtuse internal first mounting flank angle α1 may have a value ranging from one hundred degrees to one hundred and fifty degrees, i.e., 100°≤α1≤150°, and the obtuse internal second mounting flank angle α2 may have a value ranging from one hundred degrees to one hundred and thirty degrees, i.e., 100°≤α2≤130°.

Yet further, in some embodiments of the present invention, the obtuse internal first and second mounting flank angles α1, α2 may be equal.

In other embodiments of the present invention (not shown), the obtuse internal first mounting angle α1 may be greater than the obtuse internal second mounting flank α2.

Also, in other embodiments of the present invention (not shown), each female type or male type mounting element 46 may include a mounting chamfer between the first mounting flank 48 and the outer mounting surface 56.

As shown in FIG. 2, each primary cutting edge 32 has a radially outermost cutting point NC, and each cutting portion 30 has a radial cutting plane PC containing the central axis AC and the radially outermost cutting point NC of its associated primary cutting edge 32.

In some embodiments of the present invention, the radially outermost cutting point NC of each primary cutting edge 32 may be contained in the main cutting edge-portion 38.

For embodiments of the present invention in which each relief surface 36 comprises first and second relief sub-surfaces 36a, 36b, as shown in FIG. 2, each radial cutting plane PC forms an acute first relief angle ϕ1 with a straight first imaginary relief line LR1 coincident with or tangential to the associated first relief sub-surface 36a.

In some embodiments of the present invention, the acute first relief angle ϕ1 may have a value equal to or greater than fifty degrees, i.e., ϕ1≥50°.

For embodiments of the present invention in which each relief surface 36 comprises first and second relief sub-surfaces 36a, 36b, as shown in FIG. 2, each radial cutting plane PC forms an acute second relief angle ϕ2 with a straight second imaginary relief line LR2 coincident with or tangential to the associated second relief sub-surface 36b.

In some embodiments of the present invention, the acute second relief angle ϕ2 may have a value of equal to or greater than twenty-five degrees, i.e., ϕ2≥25°.

In the end view of the cutting insert 20, as shown in FIG. 2, the plurality of N radially outermost cutting points NC may define a first imaginary circle C1 having a first diameter D1 and a center coincident with the central axis AC.

In some embodiments of the present invention, in the end view of the cutting insert 20, as shown in FIG. 2, the first imaginary circle C1 may circumscribe the peripheral side surface 24.

Also, in some embodiments of the present invention, as shown in FIG. 4, the first and second planes P1, P2 may be spaced apart by a cutting width WC, and the cutting width WC may be less than twenty-five percent of the first diameter D1, i.e., WC<0.25*D1.

As shown in FIG. 2, the cutting insert 20 may comprise a plurality of N imaginary insert sectors SI1, SI2, SI3, SI4, SI5 defined by the plurality of N radial cutting planes PC.

In some embodiments of the present invention, the plurality of N equal imaginary sectors SI1, SI2, SI3, SI4, SI5 may be of equal angular extent, and each imaginary sector SI1, SI2, SI3, SI4, SI5 may subtend an angular extent of 360/N degrees.

Also, in some embodiments of the present invention, in the end view of the cutting insert 20, as shown in FIG. 2, each second mounting flank 50 may be entirely located in one of the plurality of N imaginary sectors SI1, SI2, SI3, SI4, SI5.

As shown in FIGS. 4 and 5, a fifth plane P5 perpendicular to the central axis AC intersects the plurality of N female type or N male type mounting elements 46 and their associated first and second mounting flanks 48, 50.

In some embodiments of the present invention, the fifth plane P5 may be located closer to the median plane M than the first plane P1.

As shown in FIG. 6, in a cross-section taken in the fifth plane P5, each first mounting flank 48 has a radially outermost first flank point NO1, each second mounting flank 50 has a radially outermost second flank point NO2, and the radially outermost second flank point NO2 of each second mounting flank 50 is located further from the central axis AC than the radially outermost first flank point NO1 of its associated opposing first mounting flank 48.

It should be appreciated that each radially outermost first flank point NO1 is the radial outer end point of its associated first mounting flank 48, in the cross-section taken in the fifth plane P5, and each radially outermost second flank point NO2 is the radial outer end point of its associated second mounting flank 50, in the cross-section taken in the fifth plane P5.

In some embodiments of the present invention, as shown in FIG. 6, in the cross-section taken in the fifth plane P5, the plurality of N radially outermost first flank points NO1 may lie on a second imaginary circle C2 having a second diameter D2 and a center coincident with the central axis AC, and the plurality of N radially outermost second flank points NO2 may lie on a third imaginary circle C3 having a third diameter D3 and a center coincident with the central axis AC.

Also, in some embodiments of the present invention, the third diameter D3 may be greater than the second diameter D2.

Further, in some embodiments of the present invention, the third diameter D3 may be less than seventy percent of the first diameter D1, i.e., D3<0.70*D1.

As shown in FIG. 6, each mounting element 46 has a radial mounting plane PM containing the central axis AC and the radially outermost second flank point NO2 of its associated second mounting flank 50.

In some embodiments of the present invention, each radial mounting plane PM may intersect one of the plurality of N transition surfaces 40 on the same side of the central axis AC as its associated radially outermost second flank point NO2.

As shown in FIG. 6, each transition surface 40 forms an acute or right-angle transition angle θ with its associated radial mounting plane PM.

In some embodiments of the present invention, the acute transition angle θ may have a value from seventy degrees to ninety degrees, i.e., 70°≤θ≤90°.

As shown in FIG. 6, in the cross-section taken in the fifth plane P5, a fourth imaginary circle C4 having a fourth diameter D4 and a center coincident with one of the plurality of N radially outermost cutting points NC intersects the third imaginary circle C3.

In some embodiments of the present invention, the fourth imaginary circle C4 may not intersect the central mounting portion 28.

As shown in FIG. 6, the plurality of N radially outermost cutting points NC may define a regular N-sided first polygon PY1 having a center coincident with the central axis AC.

Also, as shown in FIG. 6, the plurality of N radially outermost second flank points NO2 may define a regular N-sided second polygon PY2 having a center coincident with the central axis AC.

In some embodiments of the present invention, the N-sided first and second polygons PY1, PY2 may be circumferentially non-coincident.

It should be appreciated throughout the description and claims that the term ‘circumferentially non-coincident’ refers to two regular N-sided polygons having coincident centers which are rotationally offset from each other.

Also, in some embodiments of the present invention, the second polygon PY2 may be rotationally offset from the first polygon PY1 by an acute offset angle λ of greater than 360/N*3 degrees.

Thus, for embodiments of the present invention in which N equals five, i.e., N=5, the acute offset angle λis greater than twenty-four degrees, i.e., λ>24°.

For such embodiments of the present invention, it should be appreciated that the fourth imaginary circle's fourth diameter D4 may be advantageously increased without intersecting the central mounting portion 28.

It should also be appreciated that the acute offset angle λ may be measured in the cross-section taken in the fifth plane P5, as shown in FIG. 6, between the radial mounting plane PM associated with one of the plurality of radially outermost second flank points NO2 and the radial cutting plane PC associated with the radially outermost cutting point NC located closest to said one of the plurality of radially outermost second flank points NO2.

As shown in FIG. 6, the regular N-sided second polygon PY2 may be circumferentially coincident with the regular N-sided polygonal shape of the central mounting portion 28.

As shown in FIG. 6, in the cross-section taken in the fifth plane P5, each second mounting flank 50 has a radially innermost second flank point NI2.

It should be appreciated that each radially innermost second flank point NI2 is the radial inner end point of its associated second mounting flank 50, in the cross-section taken in the fifth plane P5.

In some embodiments of the present invention, the plurality of N radially innermost second flank points NI2 may lie on a fifth imaginary circle C5 having a center coincident with the central axis AC.

Also, in some embodiments of the present invention, the fifth imaginary circle C5 may intersect the plurality of first mounting flanks 48.

Further, in some embodiments of the present invention, each radial mounting plane PM may contain the radially innermost second flank point NI2 of its associated second mounting flank 50.

For embodiments of the present invention in which each radial mounting plane PM contains the radially outermost and innermost second flank points NO2, NI2 of its associated second mounting flank 50, it should be appreciated that the capability of each second mounting flank 50 to transfer moments of force about the central axis AC is optimized.

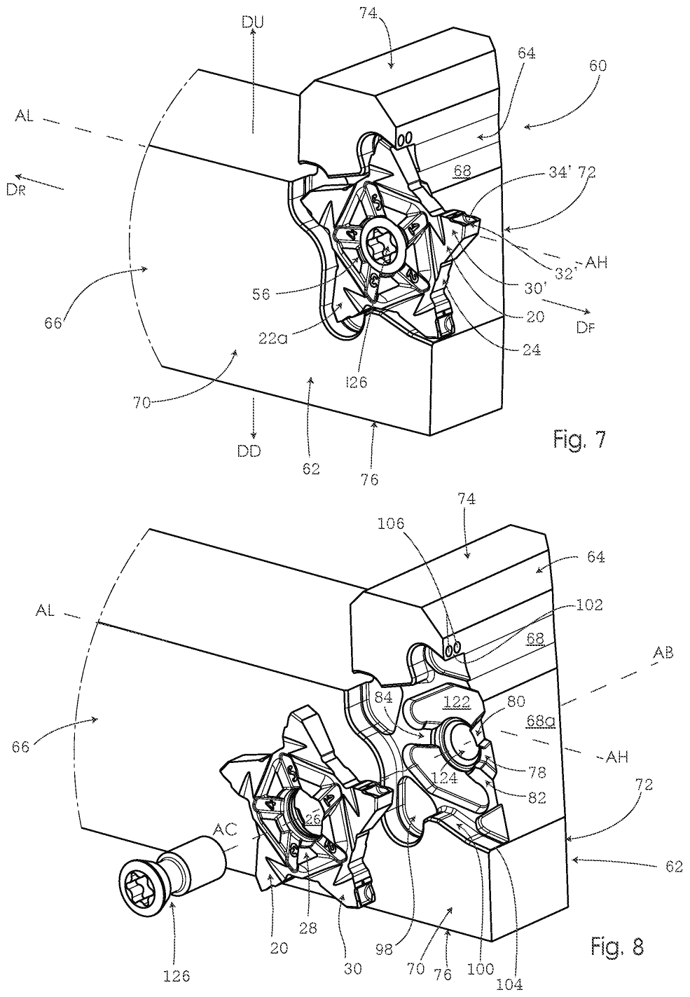

Attention is now drawn to FIGS. 7 to 11, showing a cutting tool 60 comprising an insert holder 62, and the cutting insert 20 retained therein.

As shown in FIGS. 7 to 11, the cutting tool 60 is configured as a left-handed cutting tool 60.

It should be appreciated that for embodiments of the invention in which the cutting insert 20 exhibits mirror symmetry about the median plane M, the cutting tool 60 may also be configured as a right-handed cutting tool.

The insert holder 62 has a holding portion 64 extending along a holding axis AH in a forward to rearward direction DF, DR, and the cutting insert 20 is removably securable to the holding portion 64 in any one of N index positions.

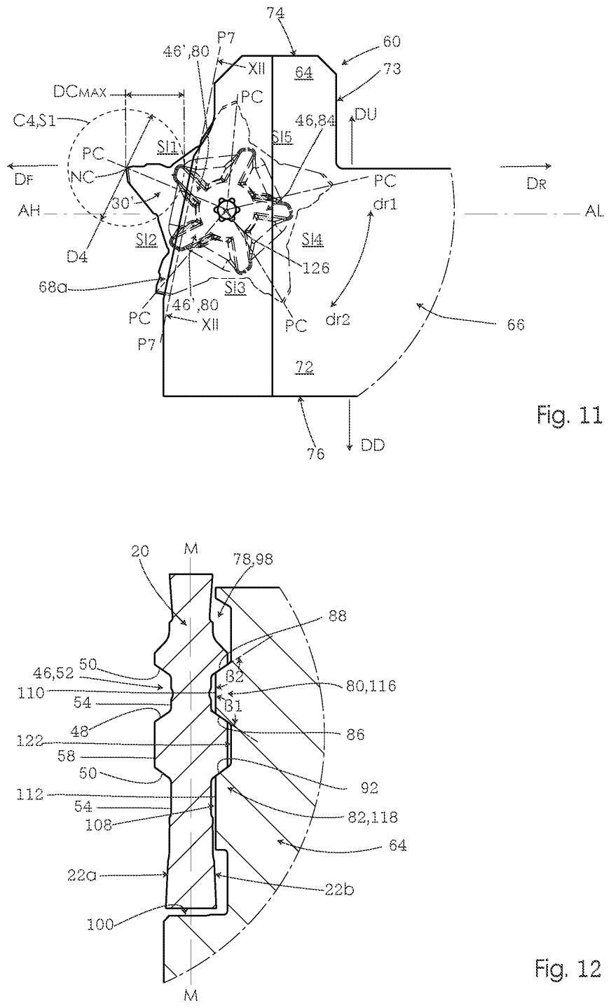

As shown in FIGS. 7 and 11, the holding portion 64 has a front holding surface 68 facing in the forward direction DF and opposing first and second side holding surfaces 70, 72 extending rearwardly from the front holding surface 68.

In some embodiments of the present invention, the holding portion 64 may have a back holding surface 73 facing in the rearward direction DR.

Also, in some embodiments of the present invention, the opposing first and second side holding surfaces 70, 72 may be spaced apart by opposing upper and lower holding surfaces 74, 76 facing in upward and downward directions DU, DD, respectively.

Further, in some embodiments of the present invention, the back holding surface 73 may be disposed adjacent the upper holding surface 74.

As shown in FIGS. 7 to 9, the insert holder 62 may have a shank portion 66 extending away from the holding portion 64 along a longitudinal axis AL.

In some embodiments of the present invention, the shank portion 66 may extend in the rearward direction DR.

Also, in some embodiments of the present invention, the longitudinal axis AL may be parallel to or coincident with the holding axis AH.

For embodiments of the present invention in which the longitudinal axis AL is parallel to or coincident with the holding axis AH, it should be appreciated that the back holding surface 73 may be employed as a ‘stopper surface’ to facilitate repeatable assembly of the cutting tool 60 in a tool block (not shown).

In other embodiments of the present invention (not shown), the longitudinal axis AL may be perpendicular to the holding axis AH.

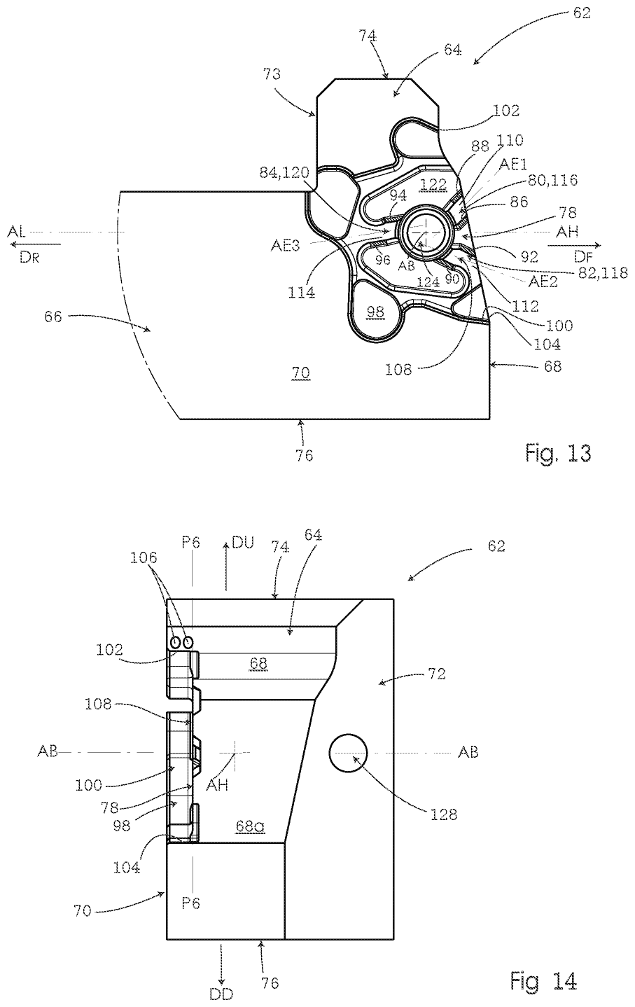

As shown in FIG. 13, the first side holding surface 70 has an engagement portion 78 comprising three male type or three female type engagement elements 80, 82, 84, each male type or female type engagement element 80, 82, 84 having opposing first and second engagement flanks 86, 88; 90, 92; 94, 96 extending along an engagement axis AE1, AE2, AE3.

In some embodiments of the present invention, the engagement portion 78 may have exactly three male type or exactly three female type engagement elements 80, 82, 84.

Also, in some embodiments of the present invention, each of the three male or female type engagement elements 80, 82, 84 may be elongated.

Further, in some embodiments of the present invention, the first and second engagement flanks 86, 88; 90, 92; 94, 96 of each of the three male type or three female type engagement elements 80, 82, 84 may be planar.

Yet further, in some embodiments of the present invention, the three male type or three female type engagement elements 80, 82, 84 may be located in an engagement recess 98 recessed in the first side holding surface 70, and the engagement recess 98 may have a recess boundary wall 100 transverse to the first side holding surface 70.

As shown in FIGS. 13 and 14, the recess boundary wall 100 may extend in an undulating manner and intersect the front holding surface 68 at a recess upper front edge 102.

In some embodiments of the present invention, the recess boundary wall 100 may also intersect the front holding surface 68 at a recess lower front edge 104.

As shown in FIG. 10, the insert's median plane M may intersect the recess boundary wall 100 and the recess upper and lower front edges 102, 104.

In some embodiments of the present invention, an internal coolant duct (not shown) may extend along the insert holder 62 from the shank portion 66 to the holding portion 64.

Also, in some embodiments of the present invention, as shown in FIG. 14, the internal coolant duct may open out to at least one coolant outlet 106 on the front holding surface 68 adjacent the recess upper front edge 102.

As shown in FIG. 14, the engagement portion 78 has an outer engagement surface 108 defining a sixth plane P6.

In some embodiments of the present invention, the outer engagement surface 108 may comprise three co-planar outer engagement sub-surfaces 110, 112, 114.

Also, in some embodiments of the present invention, the sixth plane P6 may be parallel to the holding axis AH.

Further, in some embodiments of the present invention, the sixth plane P6 may be located between the first and second side holding surfaces 70, 72.

As shown in FIG. 13, the three male type or three female type engagement type elements 80, 82, 84 may be male type engagement ridges 116, 118, 120, and the opposing first and second engagement flanks 86, 88; 90, 92; 94, 96 of each engagement element 80, 82, 84 may face away from each other.

In some embodiments of the present invention, the engagement portion 78 may have an engagement base surface 122, and the male type engagement ridges 116, 118, 120 may protrude from the engagement base surface 122.

For embodiments of the present invention in which the three male type or three female type engagement type elements 80, 82, 84 are male type engagement ridges 116, 118, 120, the first and second engagement flanks 86, 88; 90, 92; 94, 96 of each male type engagement ridge 116, 118, 120 may be spaced apart by one of the three outer engagement sub-surfaces 110, 112, 114.

As shown in FIG. 13, the engagement portion 78 may include a threaded bore 124 having a bore axis AB.

For embodiments of the present invention in which the engagement portion 78 includes a threaded bore 124 having a bore axis AB, as shown in FIG. 8, it should be appreciated that the cutting insert 20 may be removably secured to the insert holder's holding portion 64 by means of a clamping screw 126 located in the insert's central bore 26 and threadingly engaging the engagement portion's threaded bore 124.

For such embodiments of the present invention, in each index position of the cutting insert 20, the insert's central axis AC may be coaxial with the bore axis AB.

Also, in some embodiments of the present invention, as shown in FIGS. 10 and 11, the threaded bore 124 may include a non-threaded portion 128 intersecting the second side holding surface 72, and the clamping screw 126 may include recessed torque transfer geometry, e.g., TORX™ or ALLEN™ at both ends thereof.

By virtue of the threaded bore 124 intersecting the second side holding surface 72, the threaded bore 124 may be described as a through bore.

For such embodiments of the present invention, it should be appreciated that the clamping screw 126 may be accessed and tightened/untightened from both the first and second side holding surfaces 70, 72.

In a first side view of the holding portion 64, as shown in FIG. 13, the first and second engagement flanks 86, 88; 90, 92; 94, 96 of each engagement element 80, 82, 84 may be located on opposite sides of their associated engagement axis AE1, AE2, AE3, and each engagement axis AE1, AE2, AE3 may traverse the threaded bore 124.

In each index position of the cutting insert 20, as shown in FIGS. 11 and 13, three of the plurality of N female type or N male type mounting elements 46 operatively engage with the three male type or three female type engagement elements 80, 82, 84, whereby the three first mounting flanks 48 of said three operative mounting elements 46′ make clamping contact with the three first engagement flanks 86, 90, 94 of the three male type or three female type engagement elements 80, 82, 84, and the three second mounting flanks 50 of said three operative mounting elements 46′ make clamping contact with the three second engagement flanks 88, 92, 96 of the three male type or three female type engagement elements 80, 82, 84.

For such embodiments of the present invention, it should be appreciated that, in each index position of the cutting insert 20, either three female type mounting elements 46 operatively engage with three male type engagement elements 80, 82, 84, as shown in FIGS. 11 and 13, or three male type mounting elements operatively engage with three female type engagement elements (not shown).

For embodiments of the present invention in which the engagement portion 78 has exactly three male type or exactly three female type engagement elements 80, 82, 84, it should be appreciated that exactly three of the plurality of N female type or N male type mounting elements 46 operatively engage with the exactly three male type or three female type engagement elements 80, 82, 84.

For embodiments of the present invention in which the cutting insert 20 exhibits N-fold rotational symmetry about the central axis AC, it should be appreciated that the cutting insert 20 may be advantageously indexed by simply rotating the cutting insert 20 about its central axis AC, after untightening the clamping screw 126.

As shown in FIG. 11, a seventh plane P7 transverse to the holding axis AH intersects the holding portion 64 and the cutting insert 20 forward of the bore axis AB and the central axis AC.

As partially shown and appreciated in FIG. 12, in a cross-section taken in the seventh plane P7, the first and second engagement flanks 86, 88; 90, 92; 94, 96 of each male type engagement ridge 116, 118, 120 may form obtuse internal first and second engagement flank angles β1, β2, respectively, with their associated outer engagement sub-surface 110, 112, 114.

In some embodiments of the present invention, the three first mounting flanks 48 of the three operative mounting elements 46′ may be substantially parallel to the three first engagement flanks 86, 90, 94 with which they make clamping contact, and the three second mounting flanks 50 of the three operative mounting elements 46′ may be substantially parallel to the three second engagement flanks 88, 92, 96 with which they make clamping contact.

In each index position of the cutting insert 20, only one of the cutting portions 30 is an operative cutting portion 30′.

Due to the cutting insert 20 being configured with each second mounting flank 50 extending further from the central axis AC than its associated opposing first mounting flank 48, it should be appreciated that clamping contact between the three second mounting flanks 50 of the three operative mounting elements 46′ and the three second engagement flanks 88, 92, 96 occurs further from the central axis AC than clamping contact between the three first mounting flanks 48 of the three operative mounting elements 46′ and the three first engagement flanks 86, 90, 94, thus providing good support against cutting forces FC acting on the single operative cutting portion 30′ in the second rotational direction dr2 about the central axis AC.

For parting operations in which cutting forces FC are directed parallel to the median plane M, and for embodiments of the present invention in which the fifth plane P5 is located closer to the median plane M than the first plane P1, it should be appreciated that cutting forces FC acting on the single operative cutting portion 30′ in the second rotational direction dr2 about the central axis AC are efficiently transferred between the three second mounting flanks 50 of the three operative mounting elements 46′ and the three second engagement flanks 88, 92, 96.

As partially shown and appreciated in FIG. 12, the cutting insert's plurality of N co-planar mounting sub-surfaces 58 may be spaced apart from the insert holder's engagement base surface 122.

Also, as partially shown and appreciated in FIG. 12, the cutting insert's plurality of N intermediate surfaces 54 may be spaced apart from the three outer engagement sub-surfaces 110, 112, 114.

In some embodiments of the present invention, apart from the first and second mounting flanks 48, 50 of the three operative mounting elements 46′ making clamping contact with the first and second engagement flanks 86, 88; 90, 92; 94, 96 of the three male type or three female type engagement elements 80, 82, 84, the cutting insert's central mounting portion 28 may be devoid of contact with the insert holder's holding portion 64.

Thus, for embodiments of the present invention in which N equals five, i.e., N=5, it should be appreciated that, in each index position of the cutting insert 20, two of the five female type or male type mounting elements 46 may not operatively engage with male type or female type engagement elements of the engagement portion 78, and the first and second mounting flanks 48, 50 of said two non-operative mounting elements 46 may be devoid of contact with the insert holder's holding portion 64.

For such embodiments of the present invention, it should be appreciated that each of the first and second mounting flanks 48, 50 is configured to make clamping contact in three index positions of the cutting insert 20.

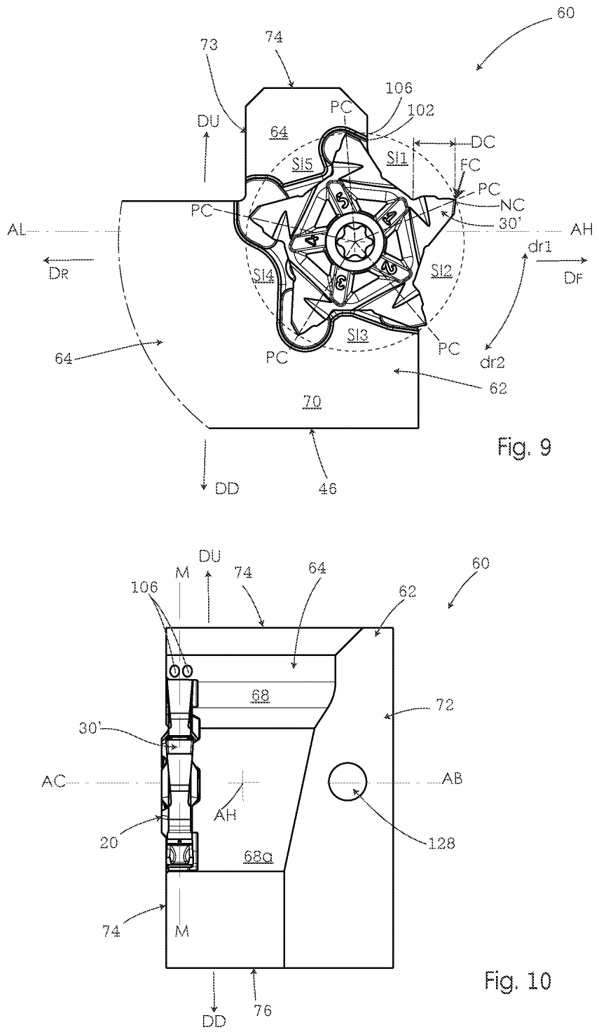

As shown in FIG. 9, in a first side view of the cutting tool 60, the recess boundary wall 100 may circumferentially envelop greater than half the cutting insert's peripheral side surface 24.

In some embodiments of the present invention, the cutting insert's peripheral side surface 24 may be in close proximity to the recess boundary wall 100 at certain circumferential regions, although the peripheral side surface 24 may be entirely spaced apart from the recess boundary wall 100.

For such embodiments of the present invention, it should be appreciated that the engagement recess 98 advantageously prevents incorrect placement of the cutting insert 20 therein.

In some embodiments of the present invention, the cutting insert's entire peripheral side surface 24 may be devoid of contact with the insert holder's holding portion 64.

For such embodiments of the present invention, it should be appreciated that the shape and formation of the cutting insert's peripheral side surface 24 may be advantageously unconstrained by considerations of interfacing contact within the insert holder's engagement portion 78.

As shown in FIG. 11, the single operative cutting portion 30′ may extend beyond the front holding surface 68 in the forward direction DF.

In some embodiments of the present invention, the operative primary cutting edge 32′ may be the forwardmost one of the plurality of N primary cutting edges 32.

As shown in FIG. 9, the cutting tool 60 has a cutting depth DC in a direction parallel to the holding axis AH.

In some embodiments of the present invention, the cutting tool 60 may have a maximum cutting depth DCmax equal to half the fourth diameter D4, i.e., DCmax=D4/2.

For embodiments of the present invention in which the fourth imaginary circle C4 intersects the third imaginary circle C3 but does not intersect the central mounting portion 28, it should be appreciated that the maximum cutting depth DCmax is advantageously large.

As shown in FIGS. 6 and 11, the fourth imaginary circle C4 defines a first imaginary cylinder S1 extending along a first cylinder axis AS1 parallel to the central axis AC.

In some embodiments of the present invention, the first imaginary cylinder S1 may not intersect the front holding surface 68.

For such embodiments of the present invention, it should be appreciated that the cutting tool 60 is capable of performing parting operations in which the first imaginary cylinder S1 represents a rotating workpiece.

In the first side view of the holding portion 64, as shown in FIG. 13, first and second engagement elements 80, 82 of the three male type or three female type engagement elements 80, 82, 84 may be located forward of the bore axis AB, and a third engagement element 84 of the three male type or three female type engagement elements 80, 82, 84 may be located rearward of the bore axis AB.

It should be appreciated that use of the terms “forward of” and “rearward of” throughout the description and claims refers to relative locations along the holding axis AH in the forward and rearward directions DF, DR, respectively.

In some embodiments of the present invention, the seventh plane P7 may intersect the first and second engagement elements 80, 82.

As shown in FIG. 11, in a projected second side view of the cutting tool 60 showing the hidden mounting elements 46 with dashed lines, the second engagement flanks 88, 92 of the first and second male type or female type engagement elements 80, 82 may be located in circumferentially adjacent first and second imaginary sectors SI1, SI2 of the plurality of N imaginary sectors SI1, SI2, SI3, SI4, SI5, respectively, and the first and second imaginary sectors SI1, SI2 of the plurality of N imaginary sectors SI1, SI2, SI3, SI4, SI5 may be delimited by the operative cutting portion's radial cutting plane PC.

For such embodiments of the present invention, it should be appreciated that two second mounting flanks 50 of the three operative mounting elements 46′ engage with two second engagement flanks 88, 92 of the three engagement elements 80, 82, 84 in close proximity to the operative cutting portion 30′, thus providing good support against cutting forces FC acting on the single operative cutting portion 30′ in the second rotational direction dr2 about the central axis AC, and stable assembly of the cutting insert 20 in the insert holder's engagement portion 78.

In some embodiments of the present invention, the first imaginary sector SI1 may subtend an angular extent of 360/N degrees in the first rotational direction dr1 about the central axis AC from the operative cutting portion's radial cutting plane PC, and the second imaginary sector SI2 may subtend an angular extent of 360/N degrees in the second rotational direction dr2 about the central axis AC from the operative cutting portion's radial cutting plane PC.

As shown in FIG. 13, the first engagement element 80 may intersect the front holding surface 68.

In some embodiments of the present invention, as shown in FIG. 11, the second engagement flank 88 of the first engagement element 80 may make clamping contact with the second mounting flank 50 of one of the three operative mounting elements 46′ immediately adjacent the front holding surface 68.

For such embodiments of the present invention, it should be appreciated that clamping contact between the second engagement flank 88 of the first engagement element 80 and the second mounting flank 50 of one of the three operative mounting elements 46′ occurs at an advantageously forward location of the insert holder 62 in close proximity to the operative cutting portion 30′.

In some embodiments of the present invention, the first engagement element 80 may intersect a first front holding sub-surface 68a of the front holding surface 68.

Also, in some embodiments of the present invention, the first front holding sub-surface 68a may be planar, and the seventh plane P7 may be parallel to the first front holding sub-surface 68a.

As shown in FIG. 13, the second engagement element 82 may intersect the front holding surface 68.

In some embodiments of the present invention, as shown in FIG. 11, the second engagement flank 92 of the second engagement element 82 may make clamping contact with the second mounting flank 50 of one of the three operative mounting elements 46′ immediately adjacent the front holding surface 68.

For such embodiments of the present invention, it should be appreciated that clamping contact between the second engagement flank 92 of the second engagement element 82 and the second mounting flank 50 of one of the three operative mounting elements 46′ occurs at an advantageously forward location of the insert holder 62 in close proximity to the operative cutting portion 30′.

In some embodiments of the present invention, the second engagement element 82 may intersect the first front holding sub-surface 68a.

As shown in FIG. 13, the recess upper front edge 102 may be located above or upward of the bore axis AB, and the recess lower front edge 104 may be located below or downward of the bore axis AB.

In some embodiments of the present invention, as shown in FIG. 9, the recess upper front edge 102 may be located in the first imaginary sector SI1 and inside the first imaginary circle C1.

Also, in some embodiments of the present invention, as shown in FIG. 9, the at least one coolant outlet 106 may be located in the first imaginary sector SI1.

For embodiments of the present invention in which the at least one coolant outlet 106 is located in the first imaginary sector SI1, and the median plane M intersects the recess upper front edge 102, it should be appreciated that coolant exiting the at least one coolant outlet 106 may be directed to the operative primary cutting edge 32′ and the adjacent operative rake surface 34′ parallel to the median plane M and in an unobstructed manner.

For embodiments of the present invention in which N equals five, i.e., N=5, in the projected second side view of the cutting tool 60, as shown in FIG. 11, the second engagement flank 94 of the third engagement element 84 may be located in a fourth imaginary sector SI4 of the plurality of five imaginary sectors SI1, SI2, SI3, SI4, SI5, and the fourth imaginary sector SI4 may be non-adjacent to the first and second imaginary sectors SI1, SI2.

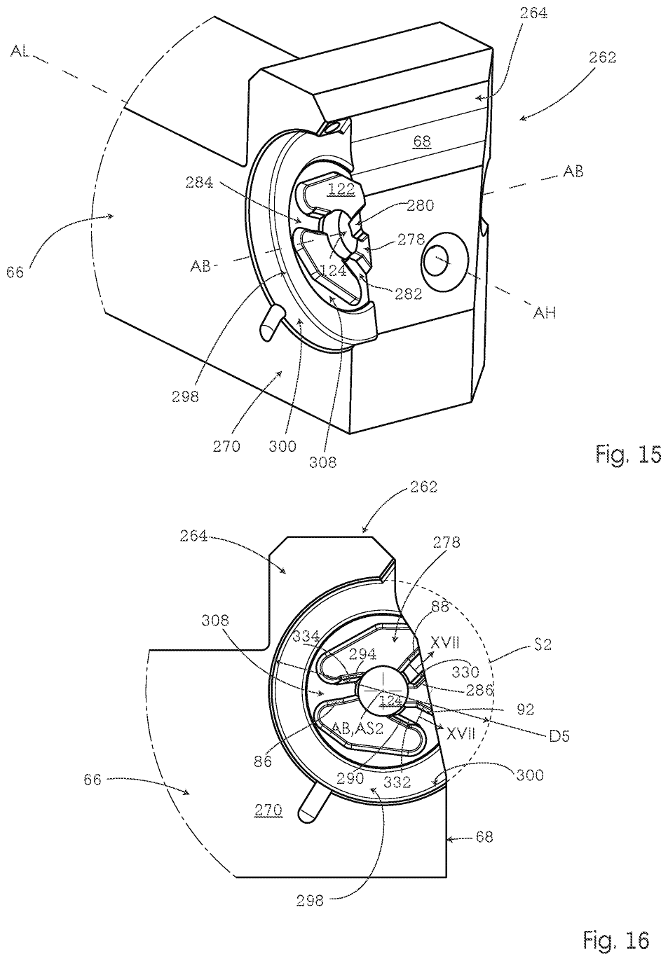

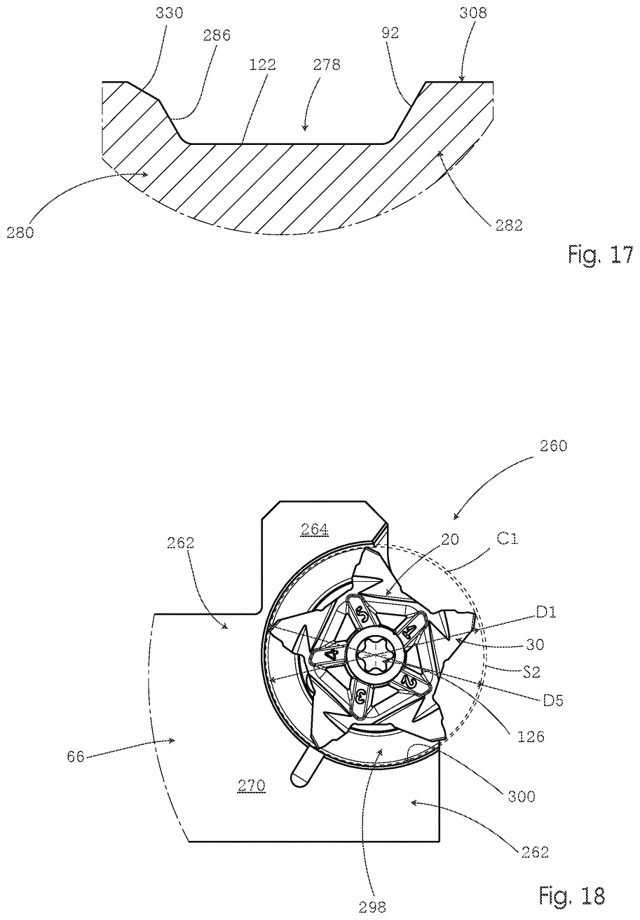

Attention is further drawn to FIGS. 15 to 18, showing an alternative embodiment of the insert holder 262 and the cutting tool 260.

It should be appreciated throughout the description and claims that features described with respect to some embodiments of the present invention may be applied to the alternative embodiment of the invention, apart from the following feature differences which warrant description using reference numerals with ‘200’ added.

In some embodiments of the present invention, as shown in FIGS. 15 and 16, the recess boundary wall 300 of the engagement recess 298 may be partially cylindrical.

As shown in FIG. 16, a second imaginary cylinder S2 having a circular cross-section and a fifth diameter D5 extends away from the outer engagement surface 308 and beyond the first side holding surface 270 along a second cylinder axis AS2 coaxial with the bore axis AB.

In some embodiments of the present invention, no portion of the engagement recess 298 may be located inside the second imaginary cylinder S2.

Also, in some embodiments of the present invention, no portion of the holding portion 264 may be located inside the second imaginary cylinder S2.

Further, in some embodiments of the present invention, as shown in FIG. 18, the fifth diameter D5 may be greater than the insert's first diameter D1.

For embodiments of the present invention in which the fifth diameter D5 is greater than the insert's first diameter D1, it should be appreciated that following disengagement of the insert's central mounting portion 28 from the holding portion's engagement portion 278, the cutting insert 20 may be advantageously indexed about its central axis AC whilst still located in the holder portion's engagement recess 298 without obstruction therefrom.

As shown in FIGS. 15 to 17, each engagement element 280, 282, 284 may include an engagement chamfer 330, 332, 334 between the first engagement flank 286, 290, 294 and the outer engagement surface 308.

For such embodiments of the present invention, it should be appreciated that the three engagement chamfers 330, 332, 334 may be devoid of contact with the three first mounting flanks 48 of the three operative mounting elements 46′, which make clamping contact with the three first engagement flanks 286, 290, 294 of the three male type or three female type engagement elements 280, 282, 284.

Also, for such embodiments of the present invention, it should be appreciated that following disengagement of the insert's central mounting portion 28 from the holding portion's engagement portion 278, the cutting insert 20 may be conveniently indexed in the first rotational direction dr1 about its central axis AC with negligible snagging against the three male type or three female type engagement elements 280, 282, 284.

Although the present invention has been described to a certain degree of particularity, it should be understood that various alterations and modifications could be made without departing from the spirit or scope of the invention as hereinafter claimed.

What is claimed is:

1. An indexable cutting insert (20) comprising:
opposing first and second end surfaces (22a, 22b) with a peripheral side surface (24) extending therebetween,
a central axis (AC) transverse to the first and second end surfaces (22a, 22b), about which the cutting insert (20) is indexable,
a median plane (M) located between the first and second end surfaces (22a, 22b),
a central bore (26) coaxial with the central axis (AC) intersecting the first and second end surfaces (22a, 22b), and
at least one of the first and second end surfaces (22a, 22b) having a central mounting portion (28),
the cutting insert (20) having a plurality of N cutting portions (30) circumferentially spaced apart about the central axis (AC), whereby Nis a specific integer number of at least three,
each cutting portion (30) having a primary cutting edge (32) formed at the intersection of a rake surface (34) and a relief surface (36), and each primary cutting edge (32) having a radially outermost cutting point (NC) and first and second end points (NE1, NE2),
the plurality of N rake surfaces (34) and the plurality of N relief surfaces (36) located on the peripheral side surface (24), and
the plurality of N rake surfaces (34) facing in a first rotational direction (dr1) about the central axis (AC),
wherein:
the central mounting portion (28) comprises a plurality of N female type or N male type mounting elements (46), each mounting element (46) having opposing first and second mounting flanks (48, 50) extending along a mounting axis (AM), each of the first and second mounting flanks (48, 50) configured to make clamping contact in at least one index position of the cutting insert (20),
and wherein in an end view of the cutting insert (20):
the first and second mounting flanks (48, 50) of each mounting element (46) are located on opposite sides of their associated mounting axis (AM),
each mounting axis (AM) traverses the central bore (26),
the plurality of N first mounting flanks (48) face in the first rotational direction (dr1) about the central axis (AC),
the plurality of N second mounting flanks (50) face in a second rotational direction (dr2) about the central axis (AC) opposite to the first rotational direction (dr1), and
each second mounting flank (50) extends further from the central axis (AC) than its associated opposing first mounting flank (48).

2. The cutting insert (20) according to claim 1, wherein, in the end view of the cutting insert (20):
the plurality of N radially outermost cutting points (NC) define a first imaginary circle (C1) having a first diameter (D1) and a center coincident with the central axis (AC).

3. The cutting insert (20) according to claim 2, wherein:
a first plane (P1) perpendicular to the central axis (AC) contains the first end point (NE1) of at least one primary cutting edge (32),
a second plane (P2) perpendicular to the central axis (AC) contains the second end point (NE2) of said at least one primary cutting edge (32),
the first and second planes (P1, P2) are located on opposite sides of the median plane (M), and
the first plane (P1) intersects the plurality of N female type or N male type mounting elements (46) and their associated first and second mounting flanks (48, 50).

4. The cutting insert (20) according to claim 3, wherein:
the first and second planes (P1, P2) are spaced apart by a cutting width (WC), and
the cutting width (WC) is less than twenty-five percent of the first diameter (D1).

5. The cutting insert (20) according to claim 1, wherein:
the plurality of N female type or N male type mounting elements (46) are female type mounting channels (52).

6. The cutting insert (20) according to claim 1, wherein:
the central mounting portion (28) has an outer mounting surface (56) defining a third plane (P3) parallel to the median plane (M).

7. The cutting insert (20) according to claim 6, wherein:
no portion of the cutting insert (20) traverses the third plane (P3).

8. The cutting insert (20) according to claim 6, wherein:
in a cross-sectional view taken in a fourth plane (P4) transverse to the mounting axis (AM) of one of the plurality of N mounting elements (46), straight first and second imaginary mounting lines (LM1, LM2) coincident with or tangential to the first and second mounting flanks (48, 50), respectively, form obtuse internal first and second mounting flank angles (α1, α2), respectively, with the outer mounting surface (56).

9. The cutting insert (20) according to claim 8, wherein:
the obtuse internal first and second mounting flank angles (α1, α2) are equal.

10. The cutting insert (20) according to claim 1, wherein:
a fifth plane (P5) perpendicular to the central axis (AC) intersects the plurality of N female type or N male type mounting elements (46) and their associated first and second mounting flanks (48, 50),
and wherein, in a cross-section taken in the fifth plane (P5):
each first mounting flank (48) has a radially outermost first flank point (NO1), each second mounting flank (50) has a radially outermost second flank point (NO2), and
the radially outermost second flank point (NO2) of each second mounting flank (50) is located further from the central axis (AC) than the radially outermost first flank point (NO1) of its associated opposing first mounting flank (48).

11. The cutting insert (20) according to claim 10, wherein, in the cross-section taken in the fifth plane (P5):
the plurality of N radially outermost first flank points (NO1) lie on a second imaginary circle (C2) having a second diameter (D2) and a center coincident with the central axis (AC),
the plurality of N radially outermost second flank points (NO2) lie on a third imaginary circle (C3) having a third diameter (D3) and a center coincident with the central axis (AC), and
the third diameter (D3) is greater than the second diameter (D2).

12. The cutting insert (20) according to claim 11, wherein:
the plurality of N radially outermost cutting points (NC) define a regular N-sided first polygon (PY1) having a center coincident with the central axis (AC),
the plurality of N radially outermost second flank points (NO2) define a regular N-sided second polygon (PY2) having a center coincident with the central axis (AC), and
the second polygon (PY2) is rotationally offset from the first polygon (PY1) by an acute offset angle (λ) of greater than 360/N*3 degrees.

13. The cutting insert (20) according to claim 11, wherein:
the third diameter (D3) is less than seventy percent of the first diameter (D1).

14. The cutting insert (20) according to claim 11, wherein, in the cross-section taken in the fifth plane (P5):
a fourth imaginary circle (C4) having a fourth diameter (D4) and a center coincident with one of the plurality of N radially outermost cutting points (NC) intersects the third imaginary circle (C3) but does not intersect the central mounting portion (28).

15. The cutting insert (20) according to claim 1, wherein, in the end view of the cutting insert (20):
the second mounting flank (50) of each mounting element (46) is located on the same side of its associated mounting axis (AM) as the central axis (AC).

16. The cutting insert (20) according to claim 1, wherein:
the cutting insert (20) exhibits mirror symmetry about the median plane (M).

17. The cutting insert (20) according to claim 1, wherein:
the cutting insert (20) exhibits N-fold rotational symmetry about the central axis (AC).

18. The cutting insert (20) according to claim 1, wherein N equals 5.

19. A cutting tool (60) comprising an insert holder (62), and a cutting insert (20) in accordance with claim 1 retained therein,
the insert holder (62) having a holding portion (64) extending along a holding axis (AH) in a forward to rearward direction (DF, DR), and the cutting insert (20) removably securable to the holding portion (64) in any one of N index positions,
the holding portion (64) having a front holding surface (68) facing in the forward direction (DF) and opposing first and second side holding surfaces (70, 72) extending rearwardly from the front holding surface (68),
the first side holding surface (70) having an engagement portion (78) comprising three male type or three female type engagement elements (80, 82, 84), each engagement element (80, 82, 84) having opposing first and second engagement flanks (86, 88; 90, 92; 94, 96) extending along an engagement axis (AE1, AE2, AE3),
wherein, in each index position of the cutting insert (20):
three of the plurality of N female type or N male type mounting elements (46) operatively engage with the three male or female type engagement elements (80, 82, 84),
the three first mounting flanks (48) of said three operative mounting elements (46′) make clamping contact with the three first engagement flanks (86, 90, 94) of the three male type or three female type engagement elements (80, 82, 84),
the three second mounting flanks (50) of said three operative mounting elements (46′) make clamping contact with the three second engagement flanks (88, 92, 96) of the three male type or three female type engagement elements (80, 82, 84),
only one of the cutting portions (30) is an operative cutting portion (30′), and
the single operative cutting portion (30′) extends beyond the front holding surface (68) in the forward direction (DF).

20. The cutting tool (60) according to claim 19, wherein:
the engagement portion (78) includes a threaded bore (124) having a bore axis (AB), and
the insert's central axis (AC) is coaxial with the bore axis (AB),
and wherein, in a side view of the holding portion (64):
first and second engagement elements (80, 82) of the three male type or three female type engagement elements (80, 82, 84) are located forward of the bore axis (AB), and
a third engagement element (84) of the three male type or three female type engagement elements (80, 82, 84) is located rearward of the bore axis (AB).

21. The cutting tool (60) according to claim 20, wherein:
each of the insert's cutting portions (30) has a radial cutting plane (PC) containing the central axis (AC) and the radially outermost cutting point (NC) of its associated primary cutting edge (32), and
the cutting insert (20) comprises a plurality of N imaginary insert sectors (SI1, SI2, SI3, SI4, SI5) defined by the plurality of N radial cutting planes (PC),
and wherein, in a projected side view of the cutting tool (60):
the second engagement flanks (88, 92) of the first and second engagement elements (80, 82) are located in circumferentially adjacent first and second imaginary sectors (SI2, SI2), respectively, of the plurality of N imaginary sectors (SI1, SI2, SI3, SI4, SI5), and
the first and second imaginary sectors (SI2, SI2) of the plurality of N imaginary sectors (SI1, SI2, SI3, SI4, SI5) are delimited by the operative cutting portion's radial cutting plane (PC).

22. The cutting tool (60) according to claim 19, wherein:
the cutting insert's entire peripheral side surface (24) is devoid of contact with the insert holder's holding portion (64).

23. The cutting tool (60) according to claim 19, wherein, apart from the first and second mounting flanks (48, 50) of the three operative female type or male type mounting elements (46′) making clamping contact with the first and second engagement flanks (86, 88; 90, 92; 94, 96) of the three male type or three female type engagement elements (80, 82, 84), the cutting insert's central mounting portion (28) is devoid of contact with the insert holder's holding portion (64).

24. The cutting tool (260) according to claim 20, wherein:
the engagement portion (278) has an outer engagement surface (308),
a second imaginary cylinder (S2) having a circular cross-section and a fifth diameter (D5) extends away from the outer engagement surface (308) and beyond the first side holding surface (270) along a second cylinder axis (AS2) coaxial with the bore axis (AB),
no portion of the holding portion (264) is located in the second imaginary cylinder (S2), and
the fifth diameter (D5) is greater than the first diameter (D1).
